(19) United States
(12) Patent Application Publication
(10) Pub. No.: US 2011/0077857 A1
(43) Pub. Date: Mar. 31, 2011

(54) ROUTE SELECTION METHOD FOR A VEHICULAR NAVIGATION SYSTEM

(75) Inventors: Deepak Ramaswamy, Ypsilanti, MI (US); Sadanori Horiguchi, Novi, MI (US)

(73) Assignee: Clarion Co., Ltd., Tokyo (JP)

(21) Appl. No.: 12/568,054

(22) Filed: Sep. 28, 2009

(51) Int. Cl. G01C 21/36

(52) U.S. Cl. 701/204

(57) ABSTRACT

A route selection method for a vehicular navigation system in which at least two popular routes are identified between an origin and a destination, each of which contains at least one road link. For each identified route, a complex array from time t₀ to time tₙ is formed where t₀ represents the departure time from the origin and time tₙ represents the arrival time at the destination. The altitudes at each time tᵢ form the road components of the complex array while distances at times t₀-tₙ form the imaginary components of the complex array. A power spectral density is then calculated and, for an internal combustion engine vehicle, the power spectral density having diffuse high frequency components is selected as the route and vice versa for a hybrid or all-electric vehicle.

### BACKGROUND OF THE INVENTION

I. Field of the Invention

The present invention relates to a route selection method for a navigation system of an automotive vehicle.

II. Description of Related Art

Vehicular navigation systems have enjoyed increased popularity for automotive vehicles. Such navigation systems typically include a map database containing information relating to road links throughout the United States as well as elsewhere. These road links commonly extend between two nodes on a map.

The map database contains not only the various road links, but also various information relating to the road links. For example, the map database typically contains information relating to the position by latitude and longitude of each of the road links as well as the length and average speed along the road link. This in turn allows a cost to be assigned to each road link in the database and this cost may be either stored in the database itself or calculated from data contained in the map database.

Still further information may also be contained within the database. For example, the database may contain information relating to the altitude for each road link as well as the altitude for intermediate points along each road link.

In use, a user of the vehicle navigation system typically inputs a desired destination for the trip. Any conventional means, such as a touch screen, keyboard, mouse, joystick, speech recognition system, or the like may be used to enter the destination while the current position of the vehicle forms the origin of the trip.

After the destination has been inputted into the navigation system, the navigation system, using conventional mapping technology, identifies a plurality of routes between the origin and the destination as likely candidates for the best route between the origin and the destination. The best route usually represents the route that requires the shortest travel time or shortest travel distance.

Once the navigation system identifies the likely candidates for the best route between the origin and the destination, the navigation system identifies at least one, and more typically many, road links that will be sequentially traveled by the vehicle from the origin and to the destination for that particular route. The navigation system then sums the total cost for each of the road links in the route to determine a total route cost for that particular route. The navigation system performs the same calculations for the other routes and then identifies which route has the least total route cost. That route then forms the best route from the origin and to the destination and is displayed to the occupants of the vehicle on a screen.

These previously known navigation systems, however, fail to compensate for the altitude of the various road links between the origin and the destination and the impact of frequent elevational changes on the fuel economy of the vehicle. For example, a route containing many elevational changes, such as a route extending through a hilly region, adversely affects the fuel economy of vehicles powered solely by internal combustion engines. This adverse effect on fuel economy results primarily from the poor fuel economy which results from acceleration of the vehicle up an incline and very little fuel economy saved while the vehicle travels down a decline.

Conversely, for hybrid vehicles as well as all-electric vehicles, a hilly route, i.e. a route having many altitude changes, actually improves the fuel economy for the vehicle since such vehicles reclaim electric energy while braking the vehicle down a decline.

Consequently, while the previously known navigation systems have proven entirely adequate in identifying the best route between an origin and a destination when all of the potential routes are entirely flat, these previously known navigation systems have not been able to identify the best route, particularly in terms of fuel economy, where there are altitude or elevation changes of the vehicle between the origin and the destination.

### SUMMARY OF THE PRESENT INVENTION

The present invention provides a route selection method for a navigation system of a vehicle which overcomes the above-mentioned disadvantages of the previously known vehicular navigation systems.

In brief, in the method of the present invention the navigation system identifies at least two, and preferably more, routes between an origin and a destination entered by the user. The user may enter the origin and destination either directly, e.g. through a touch screen, keypad, voice recognition, joystick and/or the like, or from values previously stored in the navigation system. Each of the routes identified by the navigation system, furthermore, contains at least one, and more typically many, road links.

For each identified route, the navigation system then forms a complex array from time t₀ . . . tᵢ . . . tₙ where time t₀ represents the departure time from the origin and time tₙ represents the arrival time at the destination. In the complex array, the altitudes, previously stored in the map database or otherwise accessible by the navigation system, along each sequential road link from time t₀ to time tₙ form the real components of the complex array. Conversely, the distances traveled from time tᵢ to tᵢ₊₁ along each sequential road link of the route from the origin and to the destination form the imaginary components of the complex array.

After the complex array has been formed from the origin and to the destination, the power spectral density is then computed for each route. The power spectral density is preferably arranged in adjacent frequency range bins for each of the complex arrays. Routes that have frequent inclines and declines have a higher power spectral density in the higher frequencies than flatter routes.

After the power spectral density has been computed for each of the arrays, the method of the present invention iteratively selects the route having the least power spectral density in the highest frequency range bin containing the power spectral density for a vehicle powered solely by an internal combustion engine. The navigation system then displays that single route on a video display for the driver.

Conversely, for hybrids, i.e. combination internal combustion engine and electric motor driven vehicles, as well as all-electric vehicles, the method of the present invention iteratively selects the route having the highest power spectral density in the highest frequency ranges. That route is also displayed on the display device.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a plan view illustrating three optional routes between an origin and a destination;

FIG. 2 is a simplified flowchart illustrating the operation of the method of the present invention;

FIGS. 3A, 3B and 3C are exemplary Power Spectral Densities corresponding to the three routes of FIG. 1; and

FIG. 4 is a flowchart illustrating the operation of the present invention.

### DETAILED DESCRIPTION OF A PREFERRED EMBODIMENT OF THE PRESENT INVENTION

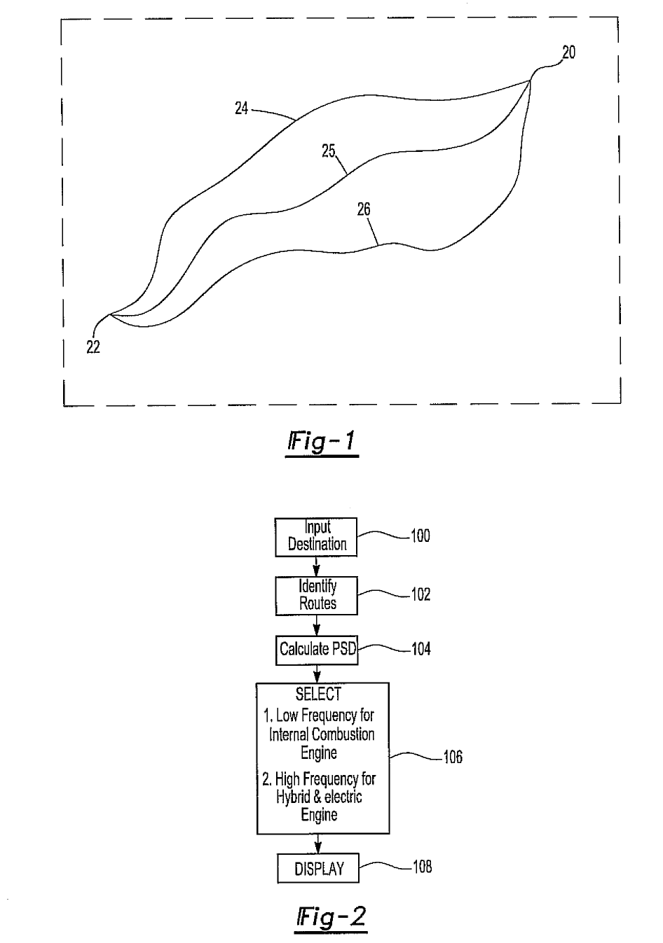

With reference first to FIGS. 1 and 2, in the route selection method of the present invention, a user first inputs at step 100 a desired destination 20 from a current point of origin 22, i.e. the current position of the vehicle. Any conventional means may be used for the user to input the destination 20 at step 100. For example, the user may use a touch screen to input address or other map data, a keyboard, joystick, speech recognition, or the like. Alternatively, the destination 20 may already be prestored by the navigation system after having been previously entered and then merely selected by the user.

After the user has inputted the destination 20 at step 100, step 100 proceeds to step 102. At step 102, the navigation system accesses a map database maintained by the navigation system which contains road link data for the appropriate geographic area relevant to the vehicle. Each road link entry in the map database, furthermore, contains information not only about the start and finish of the road link, but also data representing or at least directly related to the cost for the vehicle traveling along that particular road link. The map database also contains information of the altitude of the road link and preferably the altitude at the beginning and end of the road link so that changes in altitude from the beginning and to the end of the road link may be computed.

The navigation system then computes at least two, and typically more, routes 24, 25 and 26 between the origin 22 and destination 20. Each route 24, 25 and 26 consists of at least one, and more typically end-to-end joined road links from the origin 22 and to the destination 20.

Any conventional mathematical algorithm may be used to determine the number of routes 24-26 that are identified at step 102. For example, the navigation system may arbitrarily identify the 5 routes having the lowest cost as calculated at step 102. Even further limitations may be placed on the identification of the acceptable routes between 22 and 20. For example, a route 24, 25 or 26 may only be acceptable if its cost is less than 1.5 times the cost of the lowest cost route between the origin 22 and destination 20. In any event, after the routes 24, 25 and 26 have been identified, step 102 proceeds to step 104.

After the navigation system has calculated the routes at step 102 and proceeded to step 104, no compensation has yet been made for changes in the elevation along either the route 24, 25 or 26 to compensate if one of the routes 24-26 is hillier or subjected to more extreme elevational changes than the other. In order to account or compensate for the elevational changes of each route 24-26, step 104 calculates the power spectral density (PSD) for each route 24, 25 and 26 that has been identified at step 102.

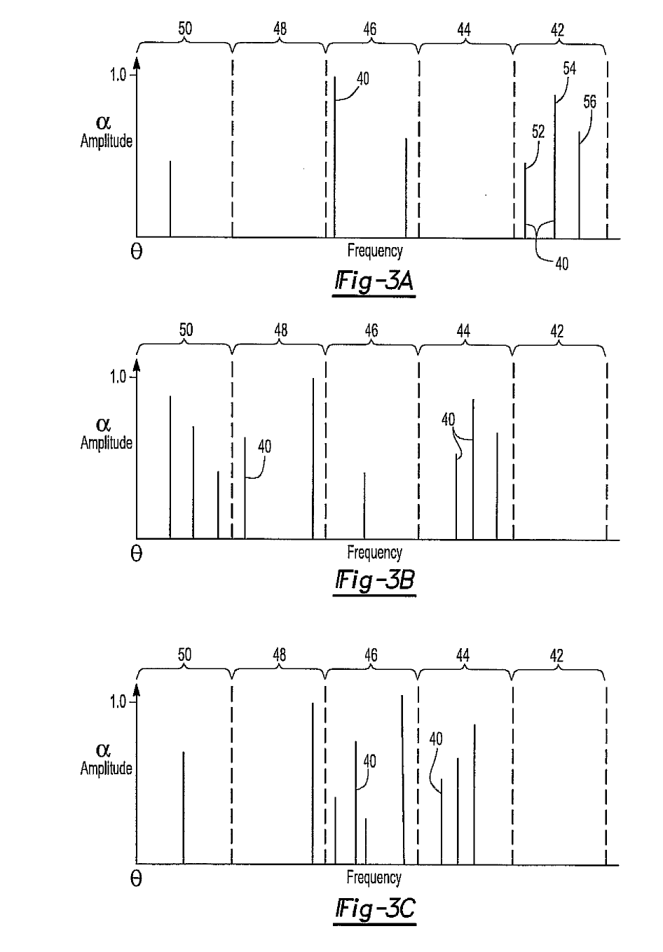

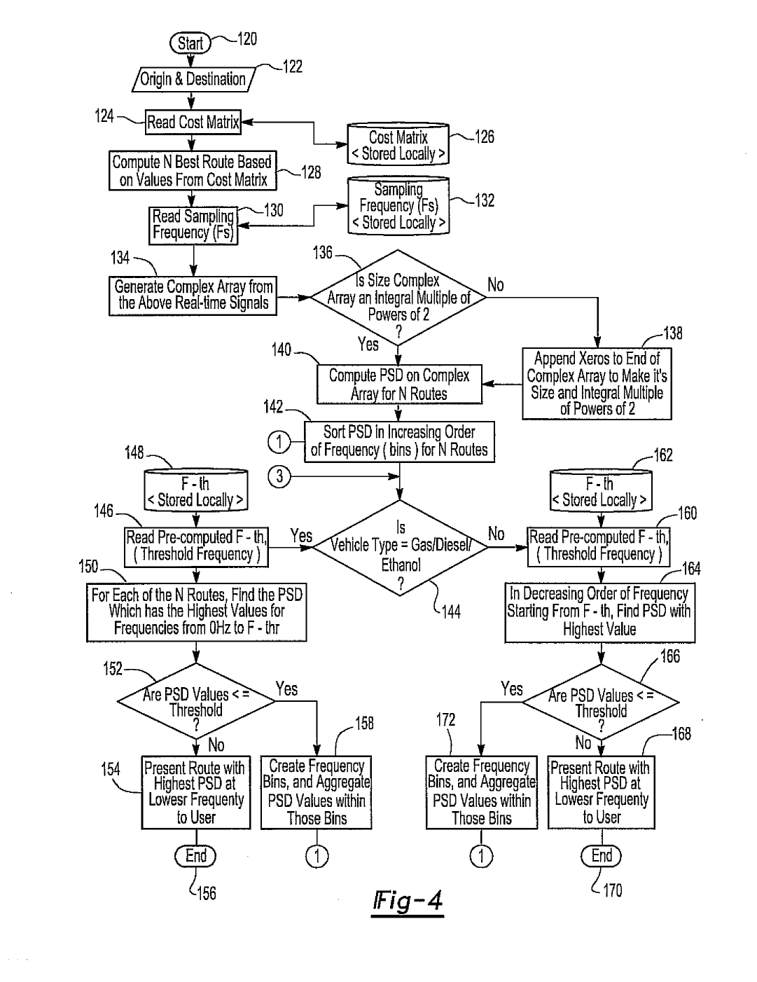

With reference now to FIG. 3, in order to calculate the PSD for each route 24 and 26, it is first necessary to convert the joint time versus distance and altitude plot of the trip required from the origin 22 and to the destination 20 into the frequency domain. To do this, for each route identified in step 102, a complex array is created beginning at time t₀ and extending to time tₙ where time t₀ represents a departure time from the origin 22 and time tₙ represents the arrival time at the destination 20. Then, by way of example, assume that the data of time versus altitude is as shown in X below

X[ ] =

| Time | t₀ | t₁ | t₂ | . . . | tᵢ | . . . | tₙ |
|---|---|---|---|---|---|---|---|
| Altitude | 180.4 | 182.6 | 190.2 | . . . | 170.8 | . . . | 160.2 |

and that an array of the distance traveled from the origin 22 as a function of time as shown in array Y

Y[ ] =

| Time | t₀ | t₁ | t₂ | . . . | tᵢ | . . . | tₙ |
|---|---|---|---|---|---|---|---|
| Distance | 0 | 0.2 | 0.4 | . . . | 30.6 | . . . | 59.8 |

Then a complex array is formed using the altitude at each time t₀-tₙ, as the real component of the complex array and the distance traveled from the origin as the imaginary component of the complex array. A complex array Z is thus formed as follows:

Z[ ]=180.4+i0,182.6+0.2,190.2+i0.4 . . . 170.8+i30.6 . . . 160.2+i59.8

Although any conventional means may be used to convert the complex array Z[ ] from the time domain to the frequency domain, preferably a Fourier transform, such as a Discrete Fourier transform, is applied to the complex array Z[ ]. A frequency distribution, and amplitude, for each of the routes 24-26 is obtained. For example, FIG. 3A represents the frequency distribution for the route 24, FIG. 3B represents the frequency distribution for the route 25, while FIG. 3C represents the frequency distribution for the route 26. All of the amplitudes a for all of the frequency distributions in FIGS. 3A-3C have been normalized to 1.0.

Referring particularly to FIGS. 3A-3C, the frequency components 40 of each complex array Z[ ] are arranged in predefined bins, each having a predetermined frequency range. For example, a first bin 42 is formed between the dashed line at a relatively high frequency while a bin 44 has a lower frequency range immediately beneath the bin 42. Similarly, other bins are also arranged in predetermined frequency ranges all the way down to bin 50 at a frequency of zero.

After calculating the Fourier Transform, Power Spectral Density of the signal (route) is computed. However, modern day software can directly take in the time-domain signal to generate PSD at its output (without explicitly providing users the result of Fourier transform). In our case, once the PSD is computed, we go on to bin the PSD frequencies and consider the sum of individual PSD within those bins. For example, as shown in FIG. 3A, there are three frequency components 52, 54 and 56 within the highest frequency bin 42. Thus, the power spectral density within the bin 42 is equal to the sum of the amplitudes of each component 52, 54 and 56 squared. Conversely, the PSD for the frequency bin 44 for route 25 (FIG. 3B) and route 26 (FIG. 3C) is Zero.

Similarly, the PSD within the next lower frequency bin 44 is substantially equal for the route 25 (FIG. 3B) and the route 26 (FIG. 3C), at least within a predefined frequency bin 44. However, the power spectral density of route 25 (FIG. 3B) for the next lower frequency bin 46 is a positive value for route 25 (FIG. 3B) but the PSD for bin 46 for route 26 (FIG. 3C) is clearly a larger value than for route 25 (FIG. 3B).

For the lowest frequency bin 50, route 25 (FIG. 3B) has the highest PSD value.

With reference now to FIGS. 2 and 3A-3C, after the calculations of the PSD as discussed above, step 104 proceeds to step 106. At step 106, the navigation system determines which of the three routes 24-26, as per the example set forth above, enjoys the best fuel economy. Furthermore, the fuel economy will vary depending if the automotive vehicle is powered solely by an internal combustion engine or whether the automotive vehicle is a hybrid electric motor and internal combustion engine (hereafter called “hybrid”), or an all-electric vehicle.

More specifically, for an automotive vehicle powered solely by an internal combustion engine, a hilly route represented by many altitude changes will result in a less desirable fuel economy for the automotive vehicle than a flat terrain. Consequently, for an automotive vehicle powered solely by an internal combustion engine, a level route is more fuel efficient than a hilly route. The opposite, however, is true for a hybrid or all-electric vehicle which achieves better fuel economy in hilly terrain than a level terrain due to its ability to regenerate electricity when traveling downhill.

Once the complex array Z[ ] has been formed and transformed into the frequency domain, a hilly route will have a higher PSD at the higher frequencies than a more level route while a level or less hilly route will have a higher PSD at lower frequencies. Consequently, in order to determine and identify the most fuel-efficient route 24-26 for an internal combustion engine powered vehicle, it is necessary to identify which route contains a higher PSD in the lower frequency bin than in the higher bins 42 and 44 and vice versa for a hybrid or all-electric vehicle.

With reference then particularly to FIGS. 3A-3C, it is clear that route 24 resulting in the frequency distribution shown in FIG. 3A contains a significantly higher PSD in the highest frequency bin 42 than in the routes 25 and 26 as represented by the frequency distribution of FIGS. 3B and 3C. Therefore, step 106 selects route 24 as a preferred or best route for hybrid or all-electric vehicles. Conversely, for an internal combustion engine powered vehicle, it is clear that the second route 25 (FIG. 3B) contains the highest PSD in the lowest frequency bin 50. Consequently, the route 25 is selected as the optimal route for such a vehicle and displayed at step 108.

It is, of course, possible that the PSD in the lowest or highest frequency bin is substantially the same for two or more routes. In this case, the PSD in the next highest frequency bin 48 (for internal combustion engine powered vehicles) or in the next lower frequency bin (for hybrid and all-electric vehicles) must be examined. For example, assume that the vehicle is a hybrid vehicle and that route 25 (FIG. 3A) must be ignored for other reasons, leaving only route 25 (FIG. 3B) and route 26 (FIG. 3B). Since the PSD in the highest frequency bin 42 is the same for both routes 25 and 26 (FIGS. 3B and 3C), i.e. zero, the next lower frequency bin 44 must be examined.

The amplitude and number of the frequency components 40 in the bin 44 is substantially the same. Therefore, the PSD in the bin 44 for both FIGS. 3B and 3C will also be substantially identical, at least within a threshold amount.

For example, if the PSD in the bin 44 in FIG. 3B equals 2.1, the PSD in the bin 44 in FIG. 3 equals 2.15 and the predefined power spectral density threshold equals 0.1, the PSD for both FIGS. 3B and 3C for the frequency bin 44 would be considered equal.

Since the PSD for the bins 42 and 44 for both FIGS. 3B and 3C are equal, or nearly so, it is necessary to examine the next lower frequency bin 46. Consequently, the PSD for the frequency bin 46 is computed for both 3B and 3C. However, it is clear that the amplitude and number of the frequency components 40 in FIG. 3C greatly outweigh the amplitude and number of frequency components 40 in FIG. 3B in the frequency bin 46. Consequently, since the PSD in the frequency bin 46 is less than the PSD in the frequency bin 46 for FIG. 3C, route 25 is selected as the best route from the origin 22 and to the destination 20 for the hybrid vehicle. This route 25 is then displayed on an appropriate video display, such as an LC screen typically contained within the passenger compartment of an automotive vehicle and visible by the driver.

Consequently, it can be seen that, to identify the route having the best fuel economy for an internal combustion engine powered vehicle, the PSD for each route is iteratively examined from the highest frequency bin downwardly towards the lowest frequency bin for a hybrid or all-electric vehicle until the route having the lower or lowest PSD in the frequency bin is identified.

For internal combustion engine powered vehicles, the process is essentially the opposite. More specifically, for such automotive vehicles, level terrain exhibits better fuel economy than hilly terrain. Consequently, for an internal combustion engine powered vehicle, step 106 in FIG. 2 searches for the route 24-26 having the highest PSD in the low frequency range. In the event that the PSD is the same or nearly so in the lowest frequency bin 50 for two or more routes, the PSD for the next higher frequency bin is iteratively examined until one route having the highest PSD is identical at step 106 and displayed at step 108.

In an alternative way of identifying the best route from N routes, the power spectral density for the lowest frequency bin for internal combustion engine vehicles are compared to determine the route having the highest power density within the lowest frequency bin. In the case, however, that two or more routes have substantially the same aggregate power spectral density, frequency bins having a smaller frequency range are allocated and the aggregate power spectral density for the smaller frequency range bin is determined for the previously identified routes. This process is iteratively repeated until one of the originally identified routes has a substantially greater power spectral density than the other routes. With respect to a hybrid or all-electric vehicle, the same process is repeated except that the routes having the highest power spectral density in the highest frequency bin are used to identify the optimal route. This process is illustrated in FIG. 4.

With reference now to FIG. 4, a flowchart illustrating the operation of the present invention is shown. After initiation of the program at step 120, step 120 proceeds to step 122. At step 122, the user enters the destination and, optionally, the origin of the desired trip into the navigation system. This may be done by a keypad, touch screen, joystick, or any other conventional input means. The navigation system may alternatively obtain the origin of the trip as the current position of the vehicle as determined by GPS. Step 122 then proceeds to step 124.

At step 124, the navigation system accesses the cost matrix for the various road links for the trip obtained from a cost matrix and map database 126. Step 124 then proceeds to step 126 in which the N best routes are identified based upon the values obtained from the cost matrix database 126. Any conventional navigation algorithm may be employed to determine the N best routes. Step 128 then proceeds to step 130.

At step 130 the navigation system obtains the sampling frequency Fₛ from a sampling frequency database 132. Typically, the sampling frequency Fₛ will be higher for short trips than for longer trips. Step 130 then proceeds to step 134.

At step 134 the navigation system generates the complex array utilizing the time, distance, and altitude for the various road links as determined from the cost matrix and road map database 126. In doing so, the distances from the origin at time t₀-tₙ may form either the real or the imaginary component of the complex array, while the altitude at time t₀-tₙ forms the other of the real or imaginary component of the complex array. Step 134 then proceeds to step 136.

In order to compute Discrete Fourier analysis on an array, it is necessary for the array to have an integral number of elements which are a power of two. Consequently, step 136 first checks the number of elements of the complex array 134 to determine if it is an integral multiple power of two. If not, step 136 branches to step 138 where zeros are appended onto the end of the complex array until the size of the complex array is an even integral multiple power of two. Step 138 then proceeds to step 140. Similarly, if the original complex array has a number of elements equal to the integral multiple of the power of two, step 136 instead branches directly to step 140.

At step 140, the power spectral density is computed for each of the N routes. Preferably, Discrete Fourier transforms are utilized to compute the power spectral density, although other means may alternatively be used. Step 140 then proceeds to step 142.

At step 142, the power spectral densities are sorted in increasing order of frequency bins for the N routes. Step 142 then proceeds to step 144.

At step 144, the navigation system determines if the vehicle uses an internal combustion engine as its primary source of propulsion or an electric motor or combination electric motor and internal combustion engine for the vehicle propulsion. Assuming that the vehicle uses an internal combustion engine as its primary source of propulsion, step 144 branches to step 146.

At step 146, the navigation system reads a determined maximum frequency Fₜₕᵣ from computer memory 148. Step 146 then proceeds to step 150 where the navigation system identifies the power spectral density which has the highest values for frequencies from zero to Fₜₕᵣ for each of the N routes. Step 150 then proceeds to step 152.

At step 152, the navigation system identifies the route having the highest power spectral density at the lowest frequency bin and then compares that power spectral density with the route having the next highest value at the lowest frequency bin. If the difference between those two power spectral density values in the lowest frequency bin exceeds a threshold, step 152 proceeds to step 154 which presents the route with the highest power spectral density at the lowest frequency bin to the user as the best route from the origin and to the destination. Step 154 then ends at step 156.

It is of course possible that the power spectral density in the lowest frequency bin for two or even more of the routes are substantially identical or in which their differences are less than a predetermined threshold. In that case, step 152 instead branches to step 158 in which new and smaller frequency bins are created. The power spectral density is then computed for each of these bins and step 158 then branches back to step 142 where the above-described process is iteratively repeated until the route having the highest power spectral density at the lowest frequency is identified and displayed to the user.

Conversely, if the vehicle is a hybrid or all-electric vehicle, step 144 instead branches to step 160 in which a predetermined minimum frequency Fₜₕ is read from computer memory 162. Step 160 then proceeds to step 164.

At step 164, starting with the frequency Fₜₕ, the power spectral density is determined for the frequency bins for each of the routes N. Step 164 then proceeds to step 166.

At step 166, the navigation system determines the difference between the power spectral density at high frequencies of the two routes having the highest power spectral density at these high frequencies. If the difference exceeds a preset threshold, step 166 proceeds to step 168 which presents the route having the highest power spectral density at the highest frequency bin to the user. Step 168 then proceeds to step 170 where the program ends.

Conversely, in the event that the power spectral density at the highest frequency bin for the two highest routes are either the same, or vary less than a predetermined threshold, step 166 instead branches to step 172 where new frequency bins having a smaller frequency range are created. Step 172 then aggregates the power spectral density values for each of those bins. Step 172 then branches back to step 142 where the above process is iteratively repeated until the route having the highest power spectral density at the highest frequency bin is identified and the appropriate route presented to the user.

From the foregoing, it can be seen that the present invention takes into account the altitude of the road link at various time intervals from the origin and to the destination in an effort to maximize fuel economy by identifying the most fuel economical route among two or more competing routes. Furthermore, the present invention achieves this for both internal combustion engine powered automotive vehicles, as well as hybrid and all-electric automotive vehicles.

It will also be understood that, while the present invention has described the method while using three separate routes 24-26, that this selection of routes 24-26, as well as the number of potential routes between the origin 22 and destination 20, is by way of example only. In practice, there may be many, many alternate routes that need to be processed between the origin 22 and destination 20 in order to identify the most fuel economical route.

It will be also understood that, while only a simple method of identifying a route having a higher PSD in the lower frequencies for an internal combustion engine powered vehicle, and in the higher frequency ranges for a hybrid or all-electric vehicle have been described, other more complex algorithms may alternatively be used to differentiate between PSD distributions in the lower frequency ranges versus the higher frequency ranges.

Having described our invention, however, many modifications thereto will become apparent to those skilled in the art to which it pertains without deviation from the spirit of the invention as defined by the scope of the appended claims.

We claim:

1. A route selection method for a navigation system of a vehicle powered by an internal combustion engine having a map database containing a plurality of road links comprising the steps of:
identifying at least two possible routes between an origin and a destination, each route containing at least one road link,
for each identified route forming a complex array from time t₀-tₙ, where time t₀ represents a departure time from the origin and time tₙ represents an arrival time at the destination, with the altitudes along each sequential road link at time t₀-tₙ and distances from the origin at time t₀-tₙ along each sequential road link each forming either the real components or the imaginary of the complex array,
calculating the power spectral density arranged in adjacent frequency range bins for each complex array,
iteratively selecting the route(s) having the highest power spectral density within a predefined threshold amount in the lowest frequency range bin containing power spectral density until a single route remains, and
thereafter displaying said single route on a video display.

2. The invention as defined in claim 1 wherein said calculating step comprises the step of performing a Fourier transformation on each complex array.

3. The invention as defined in claim 2 wherein said step of performing a Fourier transformation further comprises the step of performing a fast Fourier transformation.

4. The invention as defined in claim 1 wherein said identifying step further comprises the steps of:
(a) selecting road links which, when sequentially connected, connect the origin to the destination,
(b) retrieving a cost associated with each selected road link from the map database,
(c) adding the costs of said selected road links together to form a route cost,
(d) repeating steps (a) through (c) for a plurality of different routes,
(e) selecting a predetermined number of routes having the lowest route cost.

5. A route selection method for a navigation system in a hybrid or all-electric powered vehicle having a map database containing a plurality of road links comprising the steps of:
identifying at least two possible routes between an origin and a destination, each route containing at least one road link,
for each identified route forming a complex may from time t₀-tₙ, where time t₀ represents a departure time from the origin and time tₙ represents an arrival time at the destination, with the altitudes along each sequential road link at time t₀-tₙ forming one of the real or imaginary components of the complex array and distances from the origin at time t₀-tₙ along each sequential road link forming the other of the real or the imaginary components of the complex array,
calculating the power spectral density arranged in adjacent frequency range bins for each complex array,
iteratively selecting the route(s) having the highest power spectral density within a threshold amount in the highest frequency range bin containing power spectral density until a single route remains, and
thereafter displaying said single route on a video display.

6. The invention as defined in claim 5 wherein said calculating step comprises the step of performing a Fourier transformation on each complex array.

7. The invention as defined in claim 6 wherein said step of performing a Fourier transformation further comprises the step of performing a fast Fourier transformation.

8. The invention as defined in claim 5 wherein said identifying step further comprises the steps of:
(a) selecting road links which, when sequentially connected, connect the origin to the destination,
(b) retrieving a cost associated with each selected road link from the map database,
(c) adding the costs of said selected road links together to form a route cost,
(d) repeating steps (a) through (c) for a plurality of different routes,
(e) selecting a predetermined number of routes having the lowest route cost.

9. A route selection method for a navigation system in an automotive vehicle having a map database containing a plurality of road links comprising the steps of:
(a) identifying at least two possible routes between an origin and a destination, each route containing at least one road link,
(b) for each identified route forming a complex array from time t₀-tₙ, where time t₀ represents a departure time from the origin and time tₙ, represents an arrival time at the destination, with the altitudes along each sequential road link at time t₀-tₙ, forming one of the real or imaginary components of the complex array and distances from the origin at time t₀-tₙ along each sequential road link forming the other of the real or imaginary components of the complex array,
(c) assigning a plurality of adjacent frequency range bins,
(d) calculating the power spectral density in each bin for each complex array,
(e) selecting the route(s) having the most power spectral density within the lowest frequency range bin for internal combustion engine powered vehicles or the route(s) having the most power spectral density within the highest frequency range bin for hybrid or all electric powered vehicles,
(f) thereafter displaying said single route on a video display.

10. The invention as defined in claim 9 wherein said calculating step comprises the step of performing a Fourier transformation on each complex array.

11. The invention as defined in claim 10 wherein said step of performing a Fourier transformation further comprises the step of performing a fast Fourier transformation.

12. The invention as defined in claim 9 wherein said identifying step further comprises the steps of:
(a) selecting road links which, when sequentially connected, connect the origin to the destination,
(b) retrieving a cost associated with each selected road link from the map database,
(c) adding the costs of said selected road links together to form a route cost,
(d) repeating steps (a) through (c) for a plurality of different routes,
(e) selecting a predetermined number of routes having the lowest route cost.

13. The invention as defined in claim 9 wherein said selecting step further comprises the steps of:
in the event that two or more routes have a maximum power spectral density which differ from each other by less than a threshold amount in the lowest frequency range bin for an internal combustion engine powered vehicle or in the highest frequency range bin for hybrid or all electric powered vehicles, reassigning frequency bins having a smaller frequency range, and
iteratively repeating steps (d) and (e) until an optimal route is identified.
